(19) United States
(12) Patent Application Publication
(10) Pub. No.: US 2009/0262263 A1
(43) Pub. Date: Oct. 22, 2009

(54) Multi-standard vertical scan crt system

(76) Inventor: Richard Hugh Miller, Ephrata, PA (US)

Correspondence Address: Thomson Licensing LLC, P.O. Box 5312, Two Independence Way, PRINCETON, NJ, 08543-5312, US

(21) Appl. No.: 11/991,224

(22) PCT Filed: Jun. 5, 2006
(86) PCT No.: PCT/US2006/021637

§ 371 Date: Feb. 28, 2008

Related U.S. Application Data
(60) Provisional application No. 60/713,105, filed on Aug. 31, 2005.

(51) Int. Cl. H04N 9/16

(52) U.S. Cl. 348/805

(57) ABSTRACT

A transposed or vertical scan CRT that is compatible with multiple different input video signals so as to allow the same to operate according to different video signal transmission standards. A frame rate converter is positioned to receive incoming HDTV signals from any source. The incoming signals can be at any frame rate, for example, 24 Hz, 25 Hz, 50 Hz, 60 Hz, 72 Hz and 75 Hz. The addition of a frame rate converter provides a single vertical/horizontal display scan rate combination for all incoming signal rates.

### CROSS REFERENCE TO RELATED APPLICATIONS

This application claims the benefit of the filing date of U.S. Provisional patent application Ser. No. 60/713,105, filed on Aug. 31, 2005.

### FIELD OF THE INVENTION

The present invention relates to cathode ray tubes (CRTs) for displays such as, for example, High Definition Television (HDTV) operating in a vertical scan mode. More particularly, it relates to a vertical scan CRT and method of operating the same that is capable of maintaining a single output scan rate for any and all input signal scan rates.

### BACKGROUND OF THE INVENTION

With the ever increasing advancements in television technology, high definition television (HDTV) and the popularity of the same, the volume of HDTV transmissions continue to increase. As such, the need for displays capable of receiving and displaying HDTV images continues to increase. Concurrent with these developments, larger aspect ratio, true flat screens having shallower depths with increased deflection angles and improved visual resolution performance characteristics are increasingly in demand. There is therefore a need to provide a wide deflection angle CRT display having improved visual resolution performance in a large aspect ration screen capable of displaying HDTV images.

Improving spot performance so that spot size and shape exhibit greater uniformity across the entire screen for improved visual resolution performance. To this end, most displays now make use of dynamic focus. Increasing the deflection angle also yields an improvement in spot performance in the central area of the screen because increasing the deflection angle results in a decreased gun-to-screen distance, hereinafter referred to as the ‘throw distance’. FIG. 1 illustrates the basic geometrical relationship between throw distance and deflection angle for a typical CRT. Increasing the deflection angle (A) reduces the throw distance, thus allowing for production of a shorter CRT and ultimately, a slimmer television set. Because the general display market trend has been moving toward flatter displays which are thing, the CRT designers are being challenged to develop shorter CRTs. This means for a CRT having only one electron gun assembly, the deflection angle must be increased to diminish depth.

As the deflection angle increases, the throw distance decreases and spot size decreases in a non-linear relationship. The following formula mathematically approximates relationship between spot size and throw distance:

Spot Size≈B*Throw^{1.4} (Equation 1)

where the exponent 1.4 represents an approximation taking into consideration the effects of magnification and space charge effects over a useful range of beam current. The term B represents a system-related proportionality constant. Considering this relationship, for a tube having a diagonal dimension of 760 mm, increasing the corner to corner deflection angle from 100 degrees to 120 degrees while decreasing the center throw distance, for example, from 413 mm to 313 mm or 24%, yields a 32% reduction in spot size at the center of the screen.

Increasing the deflection angle in these displays gives rise to increases in obliquity, which is defined as the effect of a beam intercepting the screen at an oblique angle, thereby causing an elongation of the spot. The problem of obliquity becomes especially apparent in CRTs having a standard horizontal gun orientation, i.e., a CRT whose guns have a horizontal alignment along the major axis of the screen. As obliquity increases, a spot having a generally circular shape at the center of the screen becomes oblong or elongated as the spot moves toward edges of the screen. Based on this geometrical relationship, in a large aspect ratio screen, such as a 16×9 screen, the spot appears most elongated at the edges of the major axis and at the screen corners. Thus it becomes apparent that the obliquity effect causes the spot size to grow. The following equation defines the spot size radius SS_{radial}:

SS_{radial}=SSₙₒᵣₘₐₗ/cos(A) (Equation 2)

where A represents deflection angle, as measured from Dc to De as shown in FIG. 1 and nominal spot size SSₙₒᵣₘₐₗ represents the spot size without obliquity.

In addition to the obliquity effect, yoke deflection effects in self-converging CRTs having a horizontal gun orientation can compromises spot shape uniformity. To achieve self convergence, CRT's typically include a horizontal yoke that generates a pincushion shaped field and a vertical yoke that generates a barrel shaped field. These yoke fields cause the spot shape to become elongated. This elongation adds to the obliquity effect by further increasing spot distortion at the three-o'clock and nine o'clock positions (referred to as the “3/9” positions) and at corner positions on the screen.

Various attempts have been made to address spot distortion and obliquity. For example, U.S. Pat. No. 5, 170,102 describes a CRT with a vertical electron gun orientation whose un-deflected beams appear parallel to the short axis of the display screen. The deflection system described in this patent includes a signal generator for causing scanning of the display screen in a raster-scan fashion, thereby yielding a plurality of lines oriented along the short axis of the display screen. The deflection system also comprises a first set of coils for generating a substantially pincushion-shaped deflection field for deflecting the beams in the direction of the short axis of the display screen. A second set of coils generates a substantially barrel shaped deflection field for deflecting the beams in the direction in the long axis of the display screen. The deflection system's coils generally distort spots by elongating them vertically. This vertical elongation compensates for obliquity effects, thereby reducing spot distortion at the 3/9 and corner positions on the screen. The barrel shaped field required to achieve self convergence at 3/9 screen locations overcompensates for obliquity and vertically elongates the spot at the 3/9 and corner locations as shown in FIG. 10 of the U.S. Pat. No. 5, 170,102. (In effect, the barrel shaped field overcompensates, thus making the spot shape at the 3/9 position and the screen corners a vertically oriented ellipse). Orienting the electron guns along the vertical or minor axis will yield improvements in a self-converging system, but spot distortion remains problematic at the 3/9 positions and at the corner screen locations.

Notwithstanding the foregoing, even with the noted advantages of CRTs having vertically oriented inline guns and transposed scanning, the need exists for a means of implementing transposed scanning that is compatible with multiple different input video signals, such as, for example, 50 Hz, 60 Hz and 75 Hz.

### SUMMARY OF THE INVENTION

It is therefore an aspect of the present principles to provide a transposed scan CRT system capable of maintaining a constant output scan rate in the presence any incoming frame rate.

These and other aspects are achieved in accordance with an implementation of the present principles wherein the multi-standard vertical scan CRT includes a cathode ray tube having an electron gun for generating electron beams. A deflection yoke near the CRT generates magnetic fields that vertically scans the electron beams at a vertical frequency scan rate. A chassis is equipped with at least one integrated circuit capable of receiving more than one incoming video signal rate and at least one frame rate converter for converting the more than one incoming video signal rates to a selected rate. The integrated circuit and chassis are capable of directing signals to circuits that drive the deflection yoke and the electron gun to scan the electron beams at the selected output video signal rate. The frame rate converter provides a single vertical/horizontal combination for all incoming signal rates.

In accordance with other aspects of the present principles, the incoming signal rates can be in a range of 24 Hz-100 Hz, and the selected rate can be 50 Hz, 60 Hz or 75 Hz. Some examples of incoming signal rates within this range would be 24 Hz, 25 Hz, 50 Hz, 60 Hz, 72 Hz and 75 Hz.

According to another aspect of the present principles, the at least one frame rate converter is capable of accepting both progressive and interlaced incoming video signals.

The method for providing a multi-standard vertical scan CRT includes the steps of receiving input signals of different horizontal and vertical scan rates, converting all incoming frame rates to a selected scan rate, and displaying all pictures with the same selected vertical and horizontal scan rate.

The range of incoming frame rates can be 24 Hz-100 Hz, while the selected scan rate can be 50 Hz, 60 Hz or 75 Hz. The selected scan rate is a vertical scan rate having one of these operating frequencies. The conversion of all incoming frame rates provides a single vertical/horizontal combination scan rate for all incoming signal rates.

### BRIEF DESCRIPTION OF THE DRAWINGS

The invention will now be described by way of example with reference to the accompanying figures, wherein like reference numerals depict similar elements throughout the views:

FIG. 1 is a diagram depicting the basic geometrical relationship between the throw distance and deflection angle in a typical CRT;

FIG. 2 is a block diagram of a first illustrative embodiment of the present principles;

FIG. 3 is a block diagram of a detailed illustrative embodiment of the associated signal processing and electronic drive system for the CRT display according to the present principles; and

FIG. 4 is another block diagram of a detailed illustrative embodiment of the associated signal processing and electronic drive system for the CRT display according to the present principles; and

FIG. 5 is a block diagram of the multi standard transposed scan CRT according to a further aspect of the present principles.

### DETAILED DESCRIPTION

A cathode ray tube display is disclosed that comprises vertically oriented inline guns, a deflection yoke, and a means of implementing the vertical high frequency scan system for compatibility with 50 Hz signals and 60 Hz video signals as well as film frame rates 24 Hz (in the U.S.) and 25 Hz (in Europe). Also, the high frequency scan rate is intended to cover a number of signal sources, such as from 24 Hz to 100 Hz, which include the cinema modes around 24 Hz and 25 Hz input and 72 Hz to 75 Hz output. The system could be further enhanced to sense the incoming video signal rate and then automatically adapted to show the incoming signal at one of the possibilities for that signal. This selection process could be fully automatic or provide a selection to the consumer when more than one display option is possible.

By operating the high frequency scan rate near 51.56 kHz, for example, the number of high frequency scan lines and hence the active horizontal pixel count can be changed to accommodate a variety of input signals. Specifically, Table 1 below shows several specific low frequency scan rate implementations for a typical high frequency scan frequency 51.56 kHz.

TABLE 1

| | | | High Frequency |
|---|---|---|---|
| Vertical Rate | Horizontal Pixels | Vertical Pixels | Scan Rate |
| 100 Hz | 960 | 720 | 51.56 kHz |
| 75 Hz | 1280 | 720 | 51.56 kHz |
| 72 Hz | 1333 | 720 | 51.56 kHz |
| 60 Hz | 1600 | 720 | 51.56 kHz |
| 50 Hz | 1920 | 720 | 51.56 kHz |

A typical output format for a vertical scan CRT is 1280i×720 at 60 Hz. This invention increases the pixel count at 60 Hz from 1280 at 41.25 kHz high frequency scan rate to 1600 at 51.56 kHz as shown in Table 1. Other plausible high frequency vertical scan rates are conceivable in the 40 kHz to 60 kHz range output rates.

TABLE 2

| | Standard | | Standard | | | |
|---|---|---|---|---|---|---|
| | Horizontal | | Horizontal | | Vertical | |
| | Scan | | Scan | | Scan | |
| | HDTV1 | | HDTV2 | | HDTV | |
| Visual scan lines | | | | | | |
| and pixels | | | | | | |
| horizontal | 1920 | | 1280 | | 720 | |
| vertical | 1080 | | 720 | | 1280 | |
| refresh field rate | 60 | Hz | 60 | Hz | 60 | Hz |
| interlace or | Interlace | | Progressive | | Interlace | |
| progressive | | | | | | |
| Timing and Circuit | | | | | | |
| Considerations | | | | | | |
| scan line direction | Horizontal | | Horizontal | | Vertical | |
| total scan lines | 1125 | | 750 | | 1375 | |
| including retrace | | | | | | |
| pixels per scan line | 2475 | | 1650 | | 900 | |
| increase retrace | | | | | | |
| scan frequency | 33.75 | kHz | 45 | kHz | 41.25 | kHz |
| pixel clock rate | 83.5 | MHz | 74.25 | MHz | 37.125 | MHz |

The number of scan lines and pixel data listed in the Table 2 under the heading “Timing and circuit considerations” exceed the visual scan lines and pixel data, respectively, and take account of over scan and retrace. For the vertical gun alignment CRT in Table 2, the visible image field contains 1280 vertical scan lines with 720 addressable points (i.e. 720 pixels/line) on each scan line.

The three different scan systems in Table 2 afford excellent visual performance. Any visual differences due to the number of scan lines or pixels appear insignificant on a screen size having a diagonal dimension of less than 1 meter at normal viewing distances of larger than 1 meter. The vertical scan system, however, provides a significantly better image because of the better spot size/resolution of the electron beam. While the high speed scan frequency remains about the same for all systems, the vertical scan system requires significantly less scan power because the deflection angle in the vertical direction is much smaller than horizontal direction for a 16×9 aspect ratio systems. Further, the pixel clock rate for the vertical scan system is much less than the other systems. A particularly advantageous arrangement utilizes 1280 interlaced visual scan lines, which significantly reduces the deflection power requirements with no detrimental effect when displaying HDTV images.

The CRT display system of the present principles can operate at scan rates other than those listed in Table 2. A scan rate that yields vertical scan lines in the range of approximately 700 to 3000 for 16:9 format tubes in the diagonal dimensional range between approximately 20 cm and 1 m provide excellent HDTV displays under normal home viewing conditions (approximately 2 meter viewing distance).

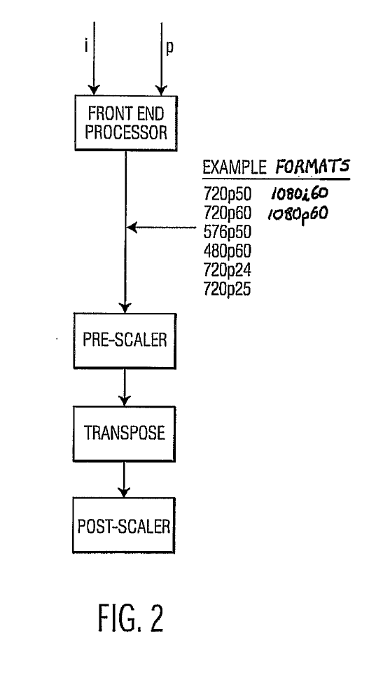

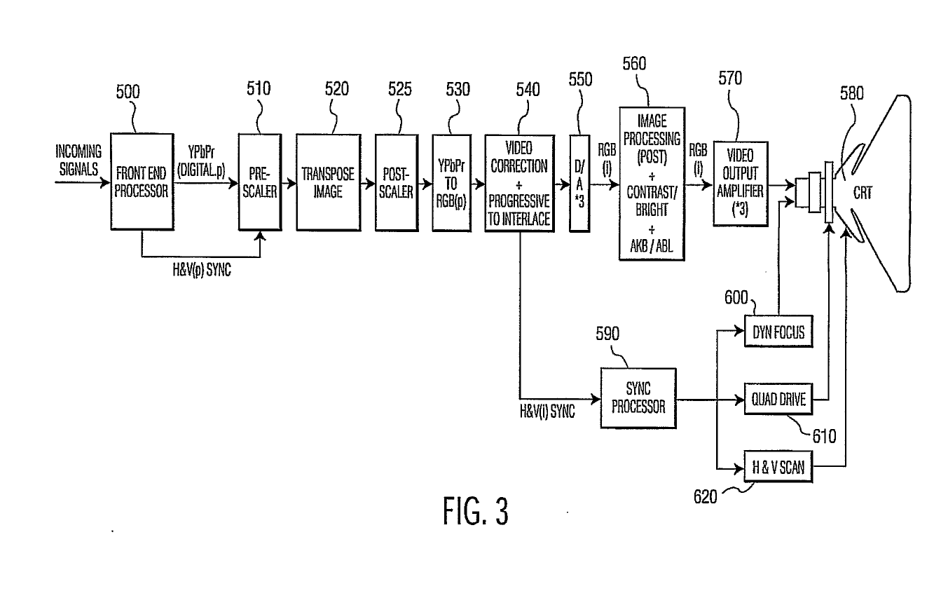

The present principles also provides for a variety of other signal formats. The implementation of the invention uses a pre-scaler and a post-scaler as shown in FIG. 2 to adjust the input pixel counts to the selected output format as shown in the Table 1. FIG. 3 is a more detailed block diagram of an implementation of the invention showing incoming signal feeding into a front end processor 500. The front-end processor 500 also generates horizontal and vertical progressive sync. The pre-scaler 510 receives the output signals from the front-end processor and initiates the adjustment of the pixel count. After the video image is transposed by the transpose operator element 520 to yield a progressive vertically scanned YPbPr signal or RGB signal, the post-scaler completes the adjustments of the input pixel format to the selected output. A format converter 530 can perform YPbPr to RGB format conversion to enable a video correction element 540 to accomplish video correction which ensures optimized convergence and geometry throughout the visible screen and ensures proper positioning of the individual red, green and blue sub-images. The element 540 can include an integrated circuit or field programmable gate array to implement a video correction element and also accomplish a conversion from progressive to interlaced vertical scanning. The digital RGB(i) interlaced vertical scan signal output by the video correction element 540 undergoes a conversion by a digital-to-analog (D/A) converter 550 yielding analog RGB(i) signals. An image processor 560 accomplishes final generation of the interlaced vertical scan signal by providing contrast, brightness, AKB, and ABL functions. A video amplifier element 570 drives the three electron guns of CRT 580 in accordance with the RGB(i) signals from the image processor 560. A sync processor 590 provides sync signals to the dynamic focus generator 600, quad drive 610, and deflection signal generator 620 in accordance with the H&V(i) signals received by the sync processor from the video correction element 540.

Other implementations of the present principles are also possible. The image quality of all implementations is influenced by the quality of the algorithm utilized to do the motion compensation. Specifically, full motion compensation algorithms or motion adaptive algorithms can be employed in any embodiment of the invention to reduce image jitter, which can be created or enhanced because of the signal processing according to the invention.

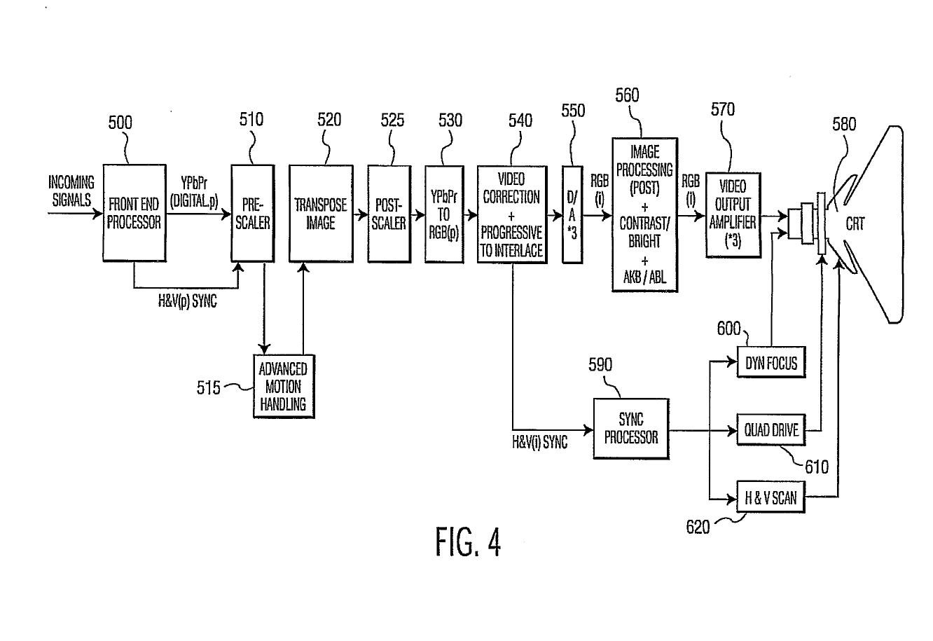

The basic (e.g. frame insertion) quality level could be enhanced by further processing block 515 as shown in FIG. 4. This implementation of a vertical scan system with a single high-frequency scan rate and multiple low frequency scan rates will permit one common basic chassis design to be utilized all over the world, adaptable to all incoming signal standards (e.g., 50 Hz and 60 Hz). Hence, simplifying the chassis design requirements of such a worldwide display system.

For example, the image quality of these implementations is influenced by the quality of the algorithm utilized to do the motion compensation. There are at least three quality levels possible: 1) basic quality from a first implementation; 2) a later improvement in quality from the implementation of motion adaptive algorithms; and 3) a highest quality from a full motion compensation algorithm in the frame rate converter. The basic quality level (e.g. frame insertion) could be enhanced by further processing block 515 as shown in FIG. 4. The first level improvement would come from motion adaptive algorithms, with motion compensation algorithms providing a further quality improvement. (FIG. 4 shows that display system of the invention without the advanced motion handling.)

This implementation of a vertical scan system with a single high-frequency scan rate and multiple low frequency scan rates will permit one common basic chassis design to be utilized all over the world, adaptable to both 50 Hz and 60 Hz standards, hence simplifying the chassis design requirements of such a display system.

Another facet of the invention allows a transposed scan CRT display system to maintain a single output scan rate for all input signals by utilizing advanced frame rate conversion algorithms. It is important to note that HDTV was first introduced in the United States using a 60 Hz frame rate and as HDTV signals are becoming common in other parts of the world, a variety of signals must now be handled by the DOS display system.

In the aforementioned examples of FIGS. 3 and 4, a variety of slow scan rates are created and the number of fast scan lines in the output images is changed to accommodate the variety of slow scan rates. However, this still requires the chassis to operate at multiple frequencies, and creates some images with relatively low pixel count that could be argued as not being HDTV images (e.g. less than 1000 pixels).

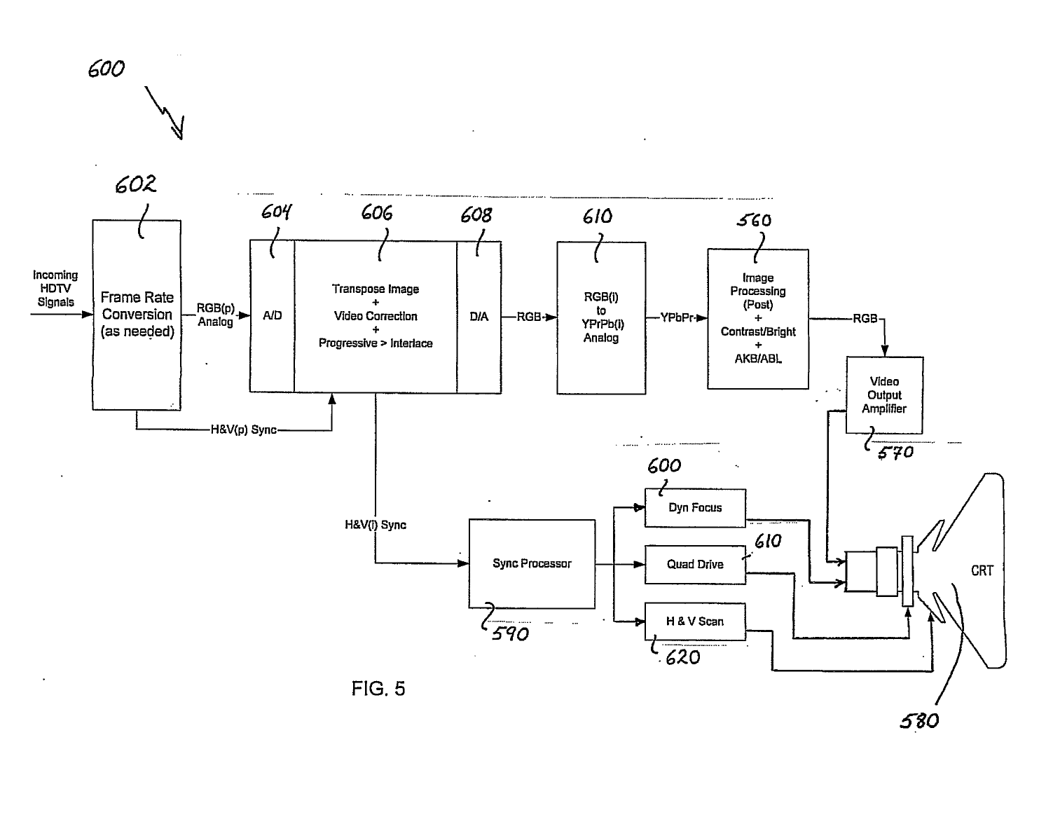

In accordance with a further implementation of the present principles, by adding a frame rate conversion block (602 in FIG. 5, which could additionally perform a de-interlacing function) between the incoming HDTV signals and the rest of the DOS signal processing, a constant output scan rate can be maintained by the transposed scan CRT display (DOS) electronics.

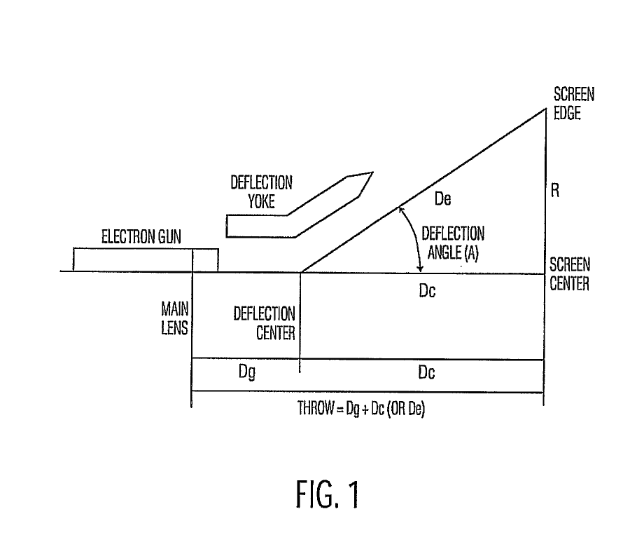

This circuit and method of FIG. 5 provides the ability to handle incoming signals with a variety of frame rates and which can be fully displayed on the existing transposed scan CRT electronics. As shown the incoming HDTV signals (of any frame rate) are input to a Frame Rate converter 602. In contrast to the embodiments of FIGS. 1-4, the frame rate converter 602 provides the option of a single vertical/horizontal combination for all incoming signal rates. Converter 602 converts all incoming frame rates to a selected vertical rate (e.g., 50, 60 or 75 Hz) such that all displayed pictures have the same selected vertical rate and the same horizontal rate.

The concept for this conversion has been demonstrated in a laboratory setup utilizing an existing frame insertion algorithm to convert from a 50 Hz signal to a 60 Hz signal and show images from both 50 Hz and 60 Hz with a single 1280(i) scan standard

The frame rate converter 602 provides the H&V(p) Sync signal to the block 606 where the image is transposed, video correction (if any) is performed, and a progressive to interlace conversion also takes place. An A/D converter 604 receives the RGB(P) analog signal from the converter 602. A D/A converter reverts the further processed signal to an analog RGB signal that is subsequently converted and processed by the remaining transposed scan CRT circuits as described in the previous embodiments.

Those of skill in the art will recognize that the quality of the displayed image is very dependent on the specific algorithms implemented in the frame rate conversion block 602. By way of example, a very basic technique (e.g., field insertion/deletion) could be utilized, or a first level improvement could utilize motion adaptive processing, with even better conversion with the implementation of fully motion adaptive processing algorithms.

A further embodiment of the circuitry of FIG. 5 would be to combine the frame rate conversion and the transpose/VC functions all into one integrated circuit (IC). This modification would permit minimization or the DDRAM requirements for the frame stores utilized for both functions.

Yet, a further embodiment would also be to enhance the processing capability of the frame rate converter 602 to include the ability to accept both progressive and interlaced video signals. With this enhancement, the display module electronics could accept the HDTV formats and also the most common 480i 60 Hz (NTSC) and 576i 50 Hz (PAL) interlaced signals.

While there has been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A vertical scan CRT comprising:
a cathode ray tube having an electron gun for generating electron beams;
a deflection yoke near said cathode ray tube, said deflection yoke generates magnetic fields that vertically scans the electron beams at a vertical frequency scan rate; and
a chassis equipped with at least one integrated circuit capable of receiving more than one incoming video signal rate and at least one frame rate converter for converting the more than one incoming video signal rates to a selected rate, the at least one integrated circuit and chassis being capable of directing signals to circuits that drive the deflection yoke and the electron gun to scan the electron beams at the selected output video signal rate;
wherein said converter provides a single vertical/horizontal combination for all incoming signal rates.

2. The vertical scan CRT of claim 1, wherein said incoming signal rates can be in a range of 24 Hz-100 Hz and said selected rate is one selected from a group consisting of 50 Hz, 60 Hz and 75 Hz.

3. The vertical scan CRT of claim 1, wherein the specific input video signal rate is one selected from a group consisting of 24 Hz, 25 Hz, 50 Hz, 60 Hz, 72 Hz and 75 Hz.

4. The vertical scan CRT of claim 1, wherein the incoming video signal rates are 24 Hz-100 Hz.

5. A vertical scan CRT comprising:
a cathode ray tube having an electron gun for generating electron beams;
a deflection yoke near said cathode ray tube, said deflection yoke generates magnetic fields that vertically scans the electron beams at a vertical frequency scan rate; and
a chassis equipped with at least one integrated circuit capable of receiving more than one incoming video signal rates and at least one frame rate converter for converting the more than one incoming video signal rates to a selected output rate, the at least one integrated circuit and chassis being capable of directing signals to circuits that drive the deflection yoke and the electron gun to scan the electron beams at the selected output video signal rate;
wherein said incoming signal rates can be in a range of 24 Hz-100 Hz and said selected output rate is one selected from a group consisting of 50 Hz, 60 Hz and 75 Hz.

6. The vertical scan CRT of claim 5, wherein sand at least one frame rate converter is capable of accepting both progressive and interlaced incoming video signals.

7. A method for providing a multi-standard vertical scan CRT comprising the steps of:
receiving input signals of different horizontal and vertical scan rates;
converting all incoming frame rates to a selected scan rate; and
displaying all pictures with the same selected vertical and horizontal scan rate.

8. The method of claim 7, wherein said converting comprises receiving incoming frame rates in a range of 24 Hz-100 Hz.

9. The method of claim 7, wherein said selected scan rate is one selected from a group consisting of 50 Hz, 60 Hz and 75 Hz.

10. The method of claim 7, wherein said converting provides a single vertical/horizontal combination scan rate for all incoming signal rates.

11. The method of claim 7, wherein the selected scan rate is a vertical scan rate.
